(19) United States
(12) Patent Application Publication
(10) Pub. No.: US 2026/0156164 A1
(43) Pub. Date: Jun. 4, 2026

(54) APPARATUS, METHOD AND COMPUTER PROGRAM

(71) Applicant: Nokia Technologies Oy, Espoo (FI)

(72) Inventors: Jian Jun BIAN, Qingdao (CN); Xuan Zhi FAN, Qingdao (CN); Li Mei YAN, Qingdao (CN); Shiwen LIU, Qingdao (CN); Rainer LIEBHART, Munich (DE); Tongqing ZHOU, Qingdao (CN); Cheng Yuan XUE, Qingdao (CN); Yong Andy YANG, Qingdao (CN); Shu Qun SONG, Qingdao (CN); Tian Da WANG, Qingdao (CN)

(21) Appl. No.: 19/125,486

(22) PCT Filed: Nov. 18, 2022
(86) PCT No.: PCT/CN2022/133018

§ 371 Date: Apr. 29, 2025

(51) Int. Cl. H04L 65/1069; H04L 65/1016; H04L 65/1104

(52) U.S. Cl. CPC H04L 65/1069; H04L 65/1016; H04L 65/1104

(57) ABSTRACT

An apparatus comprises means for receiving a request from a user equipment for establishing a bootstrap data channel with a data channel server, the request including attributes associated with the user equipment (S1), means for determining based on the attributes, an address indicating resources associated with at least one application or an application list for the user equipment (S2) and means for using the address to provide the at least one application or the application list to the user equipment via the bootstrap data channel (S3).

### FIELD

The present application relates to a method, apparatus, system and computer program and in particular but not exclusively to a method to identify a subscriber bootstrap entry page for IP Multimedia Subsystem (IMS) data channel.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

In a first aspect there is provided an apparatus comprising means for an apparatus comprising:

means for receiving a request from a user equipment for establishing a bootstrap data channel with a data channel server, the request including attributes associated with the user equipment, means for determining, based on the attributes, an address indicating resources associated with at least one application or an application list for the user equipment and means for using the address to provide the at least one application or the application list to the user equipment via the bootstrap data channel.

The apparatus may comprise means for receiving the request from the user equipment via an application server.

The apparatus may comprise means for providing the address to the user equipment.

The apparatus may comprise means for providing the address to the user equipment via an application server.

The address may be provided to the user equipment in a session description protocol message.

The apparatus may comprise means for determining, based on the attributes, a further address indicating resources associated with the at least one application or application list for a terminating device and means for providing the address to the terminating device.

The apparatus may comprise means for providing the address to a data channel media function.

A request for the at least one application or the application list may be directed from the user equipment by the data channel media function to the address.

The request for the at least one application or the application list may comprise a pre-configured address.

The apparatus may comprise means for receiving an identifier associated with the bootstrap data channel from a data channel media function and means for associating the identifier with the address.

The apparatus may comprise means for receiving a request for the address from the data channel media function, the request including the identifier.

The apparatus may comprise means for providing the address to the data channel media function based on the identifier.

A request for the at least one application or the application list may be directed from the user equipment to the address by the data channel media function.

The apparatus may comprise means for receiving a request for the at least one application or the application list from the user equipment via the data channel media function, the request including the identifier and means for directing the request to the address based on the identifier.

The apparatus may comprise a data channel application repository or a data channel signalling function or a webserver.

The address may comprise a uniform resource locator.

In a second aspect there is provided an apparatus comprising means for providing a request from a user equipment to a network function for establishing a bootstrap data channel with a data channel server, the request including attributes associated with the user equipment, means for receiving, in response to the request, an address indicating resources associated with at least one application or an application list to be provided via the bootstrap channel for the user equipment, the address determined based on the attributes and means for providing a request from the user equipment for the at least one application or the application list to the received address.

The apparatus may comprise means for providing the request for establishing a bootstrap data channel from the user equipment via an application server.

The apparatus may comprise means for receiving the address at the user equipment via an application server.

The apparatus may comprise means for receiving the address at the user equipment in a session description protocol message.

The network function may comprise a data channel application repository or a data channel signalling function or a webserver.

The address may comprise a uniform resource locator.

In a third aspect there is provided an apparatus comprising means for an apparatus comprising
receiving a request from a user equipment for establishing a bootstrap data channel with a data channel server, the request including attributes associated with the user equipment, determining, based on the attributes, an address indicating resources associated with at least one application or an application list for the user equipment and using the address to provide the at least one application or the application list to the user equipment via the bootstrap data channel.

The method may comprise receiving the request from the user equipment via an application server.

The method may comprise providing the address to the user equipment.

The method may comprise providing the address to the user equipment via an application server.

The address may be provided to the user equipment in a session description protocol message.

The method may comprise determining, based on the attributes, a further address indicating resources associated with the at least one application or application list for a terminating device and providing the address to the terminating device.

The method may comprise providing the address to a data channel media function.

A request for the at least one application or the application list may be directed from the user equipment by the data channel media function to the address.

The request for the at least one application or the application list may comprise a pre-configured address.

The method may comprise receiving an identifier associated with the bootstrap data channel from a data channel media function and associating the identifier with the address.

The method may comprise receiving a request for the address from the data channel media function, the request including the identifier.

The method may comprise providing the address to the data channel media function based on the identifier.

A request for the at least one application or the application list may be directed from the user equipment to the address by the data channel media function.

The method may comprise receiving a request for the at least one application or the application list from the user equipment via the data channel media function, the request including the identifier and directing the request to the address based on the identifier.

The apparatus may comprise a data channel application repository or a data channel signalling function or a webserver.

The address may comprise a uniform resource locator.

In a fourth aspect there is provided a method comprising providing a request from a user equipment to a network function for establishing a bootstrap data channel with a data channel server, the request including attributes associated with the user equipment, receiving, in response to the request, an address indicating resources associated with at least one application or an application list to be provided via the bootstrap channel for the user equipment, the address determined based on the attributes and providing a request from the user equipment for the at least one application or the application list to the received address.

The method may comprise providing the request for establishing a bootstrap data channel from the user equipment via an application server.

The method may comprise receiving the address at the user equipment via an application server.

The method may comprise receiving the address at the user equipment in a session description protocol message.

The network function may comprise a data channel application repository or a data channel signalling function or a webserver.

The address may comprise a uniform resource locator.

In a fifth aspect there is provided an apparatus comprising at least one processor and at least one memory storing instructions that, when executed by the at least one processor, cause the apparatus at least to receive a request from a user equipment for establishing a bootstrap data channel with a data channel server, the request including attributes associated with the user equipment, determine, based on the attributes, an address indicating resources associated with at least one application or an application list for the user equipment and use the address to provide the at least one application or the application list to the user equipment via the bootstrap data channel.

The apparatus may be caused to receive the request from the user equipment via an application server.

The apparatus may be caused to provide the address to the user equipment.

The apparatus may be caused to provide the address to the user equipment via an application server.

The address may be provided to the user equipment in a session description protocol message.

The apparatus may be caused to determine, based on the attributes, a further address indicating resources associated with the at least one application or application list for a terminating device and provide the address to the terminating device.

The apparatus may be caused to provide the address to a data channel media function.

A request for the at least one application or the application list may be directed from the user equipment by the data channel media function to the address.

The request for the at least one application or the application list may comprise a pre-configured address.

The apparatus may be caused to receive an identifier associated with the bootstrap data channel from a data channel media function and associate the identifier with the address.

The apparatus may be caused to receive a request for the address from the data channel media function, the request including the identifier.

The apparatus may be caused to provide the address to the data channel media function based on the identifier.

A request for the at least one application or the application list may be directed from the user equipment to the address by the data channel media function.

The apparatus may be caused to receive a request for the at least one application or the application list from the user equipment via the data channel media function, the request including the identifier and direct the request to the address based on the identifier.

The apparatus may comprise a data channel application repository or a data channel signalling function or a webserver.

The address may comprise a uniform resource locator.

In a sixth aspect there is provided an apparatus comprising: at least one processor and at least one memory storing instructions that, when executed by the at least one processor, cause the apparatus at least to provide a request from a user equipment to a network function for establishing a bootstrap data channel with a data channel server, the request including attributes associated with the user equipment, receive, in response to the request, an address indicating resources associated with at least one application or an application list to be provided via the bootstrap channel for the user equipment, the address determined based on the attributes and provide a request from the user equipment for the at least one application or the application list to the received address.

The apparatus may be caused to provide the request for establishing a bootstrap data channel from the user equipment via an application server.

The apparatus may be caused to receive the address at the user equipment via an application server.

The apparatus may be caused to receive the address at the user equipment in a session description protocol message.

The network function may comprise a data channel application repository or a data channel signalling function or a webserver.

The address may comprise a uniform resource locator.

In a seventh aspect there is provided a computer readable medium comprising instructions which, when executed by an apparatus, cause the apparatus to perform at least the following:
receiving a request from a user equipment for establishing a bootstrap data channel with a data channel server, the request including attributes associated with the user equipment, determining, based on the attributes, an address indicating resources associated with at least one application or an application list for the user equipment and using the address to provide the at least one application or the application list to the user equipment via the bootstrap data channel.

The apparatus may be caused to perform receiving the request from the user equipment via an application server.

The apparatus may be caused to perform providing the address to the user equipment.

The apparatus may be caused to perform providing the address to the user equipment via an application server.

The address may be provided to the user equipment in a session description protocol message.

The apparatus may be caused to perform determining, based on the attributes, a further address indicating resources associated with the at least one application or application list for a terminating device and providing the address to the terminating device.

The apparatus may be caused to perform providing the address to a data channel media function.

A request for the at least one application or the application list may be directed from the user equipment by the data channel media function to the address.

The request for the at least one application or the application list may comprise a pre-configured address.

The apparatus may be caused to perform receiving an identifier associated with the bootstrap data channel from a data channel media function and associating the identifier with the address.

The apparatus may be caused to perform receiving a request for the address from the data channel media function, the request including the identifier.

The apparatus may be caused to perform providing the address to the data channel media function based on the identifier.

A request for the at least one application or the application list may be directed from the user equipment to the address by the data channel media function.

The apparatus may be caused to perform receiving a request for the at least one application or the application list from the user equipment via the data channel media function, the request including the identifier and directing the request to the address based on the identifier.

The apparatus may comprise a data channel application repository or a data channel signalling function or a webserver.

The address may comprise a uniform resource locator.

In an eighth aspect there is provided a computer readable medium comprising instructions which, when executed by an apparatus, cause the apparatus to perform at least the following:
providing a request from a user equipment to a network function for establishing a bootstrap data channel with a data channel server, the request including attributes associated with the user equipment, receiving, in response to the request, an address indicating resources associated with at least one application or an application list to be provided via the bootstrap channel for the user equipment, the address determined based on the attributes and providing a request from the user equipment for the at least one application or the application list to the received address.

The apparatus may be caused to perform providing the request for establishing a bootstrap data channel from the user equipment via an application server.

The apparatus may be caused to perform receiving the address at the user equipment via an application server.

The apparatus may be caused to perform receiving the address at the user equipment in a session description protocol message.

The network function may comprise a data channel application repository or a data channel signalling function or a webserver.

The address may comprise a uniform resource locator.

In a ninth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a flowchart of a method according to an example embodiment;

FIG. 5 shows a flowchart of a method according to an example embodiment;

FIG. 6 shows a signalling flow according to an example embodiment.

### DETAILED DESCRIPTION

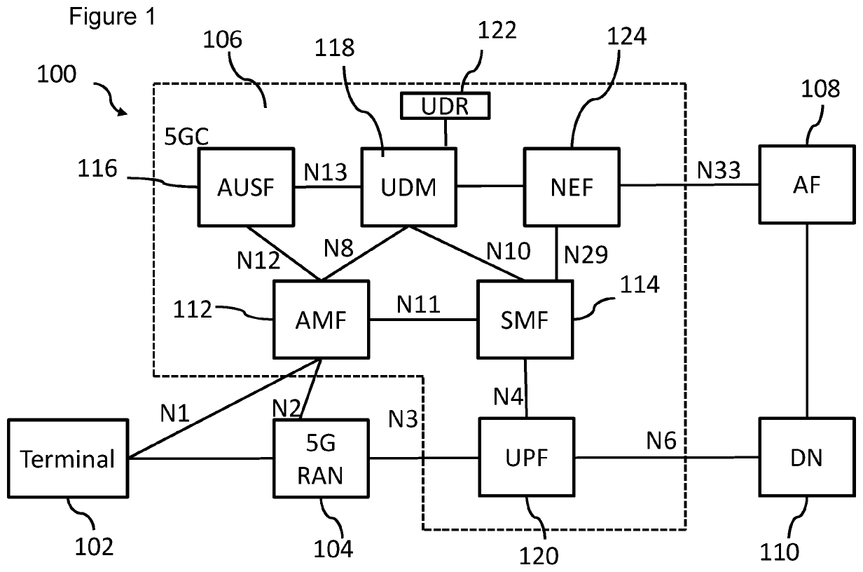

Before explaining in detail the examples, certain general principles of a wireless communication system and mobile communication devices are briefly explained with reference to FIGS. 1 to 3 to assist in understanding the technology underlying the described examples.

An example of a suitable communications system is the 5G or NR concept. Network architecture in NR may be similar to that of LTE-advanced. Base stations of NR systems may be known as next generation Node Bs (gNBs). Changes to the network architecture may depend on the need to support various radio technologies and finer QoS support, and some on-demand requirements for e.g. Quality of Service (QoS) levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more application functions (AF) 108 and one or more data networks (DN) 110.

An example 5G core network (CN) comprises functional entities. The 5GCN 106 may comprise one or more access and mobility management functions (AMF) 112, one or more session management functions (SMF) 114, an authentication server function (AUSF) 116, a unified data management (UDM) 118, one or more user plane functions (UPF) 120, a unified data repository (UDR) 122 and/or a network exposure function (NEF) 124. The UPF is controlled by the SMF (Session Management Function) that receives policies from a PCF (Policy Control Function).

The CN is connected to a UE via the radio access network (RAN). The 5GRAN may comprise one or more gNodeB (GNB) distributed unit functions connected to one or more gNodeB (GNB) centralized unit functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

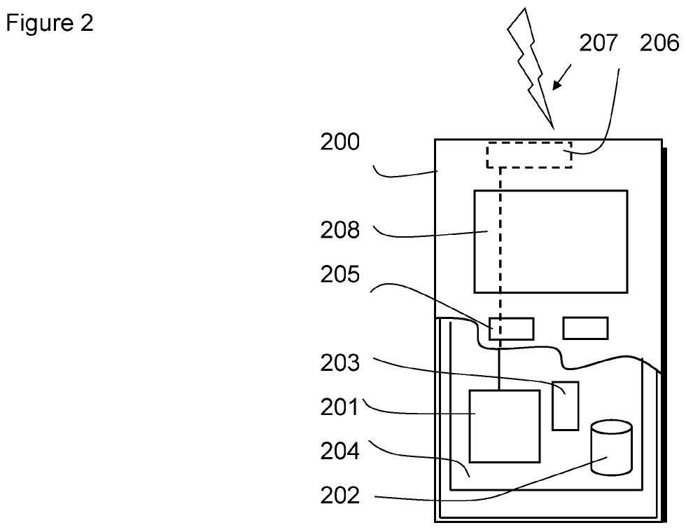

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VOIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

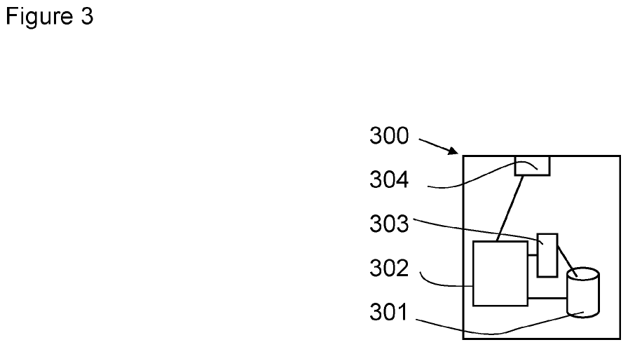

FIG. 3 shows an example of a control apparatus 300 for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

IP Multimedia Subsystem (IMS) is widely deployed to provide voice communication service. To enable IMS to handle interactive calling in addition to voice communication, an IMS Data Channel (DC) has been defined. The IMS DC uses Session Initiation Protocol (SIP)/Session Description Protocol (SDP) to perform IMS DC SDP negotiation between endpoints and a Data Channel Server (DCS). The DCS may be comprised in a DCSF (DC Signaling Function) and DCMF (DC Media Function). Based on the SDP negotiation result, the endpoint may establish a bootstrap data channel with the DCS and use HTTP/SCTP/DTLS/UDP protocol to retrieve at least one of an application list and single applications from the DCS. A bootstrap DC is a data channel via which the UE can download an application (i.e. download a HTML page with embedded JavaScript files, images and style sheets). Bootstrap DC uses certain stream IDs (below 1000), other than an application DC.

The IMS data channel may enable one or more application data channel for applications in addition to voice (e.g., inter-active chat). With the IMS data channel, data applications may be created and offered to a user without the need to pre-install applications on the user's device. Each subscriber may use different DC applications based on subscription or other conditions such as the called number or, more generally, the terminating party identity. Device capabilities (e.g., rendering capabilities), if known to the network, may be an important input when creating the application list for a subscriber using a device. Thus, the network may offer a specific DC application or list of applications to the user that is adapted to user and device needs and capabilities.

In this context, an application or application list is a HTML page with embedded JavaScript and potentially other objects like style sheets or images. The user may select any application from an application list. When the user wants to launch an application, an application data channel is established via SDP negotiation. Once an application data channel is established, the endpoint may exchange application data within the application data channel.

It has been defined in specifications that a bootstrap data channel shall use HTTP (not encapsulating HTTP in Transmission Control Protocol (TCP)), represented by the following, example SDP “a=dcmap” line, which therefore is present in data channel media descriptions in an SDP offer from a DC capable Multimedia Telephony Service for IMS (DCMTSI) client in terminal:
a=dcmap:0 subprotocol=“http”

Data channel stream IDs below 1000 are reserved for using the HTTP protocol, henceforth denoted as “bootstrap data channels”, to retrieve an HTML web page including JavaScript(s), and optionally image(s) and style sheet(s), henceforth denoted as a “data channel application”. The data channel application (accessible at the HTTP root (“/”) URL through a bootstrap data channel) describes the graphical user interface and the logic needed to handle any further data channel usage beyond the bootstrap data channel itself. The meaning of the “authority” (host) part of the URL and consequently the “Host” HTTP header are not defined, shall be ignored on reception, and shall be set to the empty value by a DCMTSI client in terminal.

Since the data channel is linked with one user, the DCS may maintain the mapping between the data channel information identified by stream-id in “dcmap” attribute in SDP during data channel establishment and user information. Stream IDs are unique within the media description. DCS will query the application repository based on user information to retrieve the application list and generate the related html and JavaScript content.

Given DCSF and DCMF are separated, either both DCSF and DCMF should maintain the data channel user information, or the DCMF must query this information from DCSF to find the correlated user info and create a specific user URL which enables the UE to download the application or application list.

When a DCMTSI client in the terminal tries to retrieve the bootstrap application list, one option is that the DCS can link the user identity (e.g., IMS IMPU) with the DC bootstrap channel (e.g., IP address, port number, stream ID, other information) and create a user specific list. However, this solution is implementation specific, and it is unclear how the DC bootstrap channel may be uniquely identified across different implementations, e.g., DCSF implemented by vendor A and DCMF by vendor B.

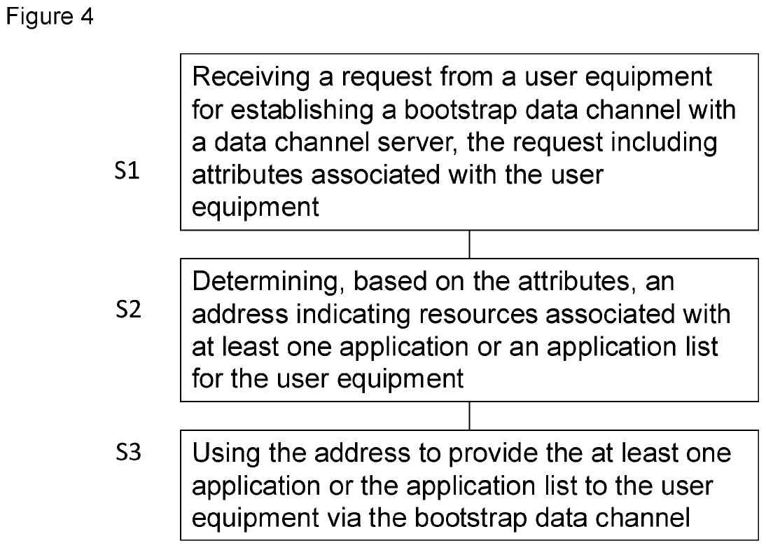

FIG. 4 shows a flowchart of a method according to an example embodiment. The method may be performed at a network function such as a DCSF or DCAR or webserver.
In S1, the method comprises receiving a request from a user equipment for establishing a bootstrap data channel with a data channel server, the request including attributes associated with the user equipment.
In S2, the method comprises determining, based on the attributes, an address indicating resources associated with at least one application or an application list for the user equipment.
In S3, the method comprises using the address to provide the at least one application or the application list to the user equipment via the bootstrap data channel.

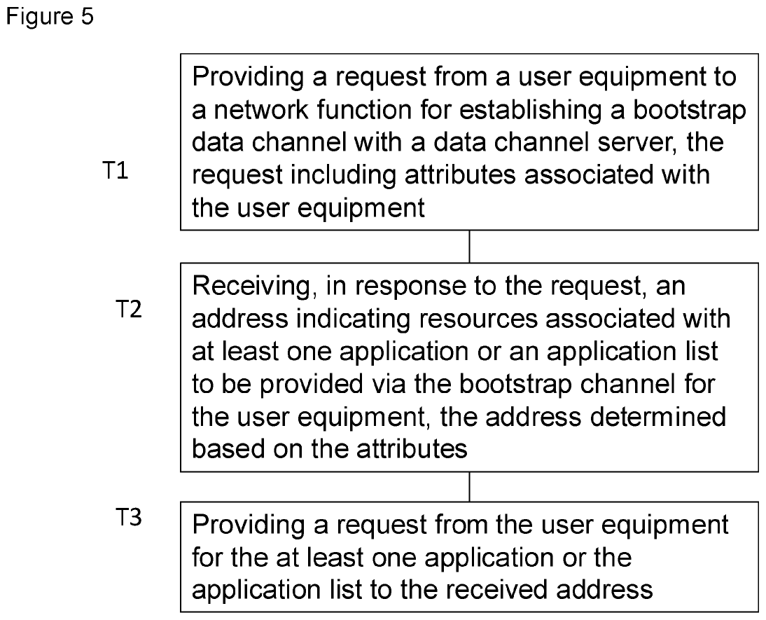

FIG. 5 shows a flowchart of a method according to an example embodiment.
In T1, the method comprises providing a request from a user equipment to a network node for establishing a bootstrap data channel with a data channel server, the request including attributes associated with the user equipment.
In T2, the method comprises receiving, in response to the request, an address indicating resources associated with at least one application or an application list to be provided via the bootstrap channel for the user equipment, the address determined based on the attributes.
In T3, the method comprises providing a request from the user equipment for the at least one application or the application list to the received address.

The address may comprise a URL.

The attributes may comprise at least one of the following: device capabilities, subscription information or terminating party information.

The request for establishing a bootstrap data channel may be provided from the user equipment to the network function via an application server, e.g., IMS AS. The data channel server (DCS) is comprised in a DCMF and DCSF. The bootstrap channel may be established between the UE and a DCMF. Signalling to establish this channel may go from UE to IMS AS and further to DCSF.

The method may comprise providing the address to the user equipment. The address may be provided to the user equipment via an application server, e.g., IMS AS. The method may comprise determining, based on the attributes, a further address indicating resources associated with the at least one application or application list for a terminating device and providing the further address to the terminating device.

In an example embodiment, a DCSF receives data that are extracted from the SDP offer from DCMTSI client in a terminal. DCSF allocates a specific URL for bootstrap applications dedicated for the user, based on user's subscription, called party identification, other relevant data and operator policies.

In one example embodiment, DCSF provides this URL to IMS AS which includes it in “request-target” parameter of “dcsa” attribute of the SDP answer. See an example in Table 1 below.

TABLE 1
SDP answer

m=application 55698 UDP/DTLS/SCTP webrtc-datachannel
c=IN IP4 172.17.176.1
a=ice-ufrag:l/xD
a=ice-pwd:TYk1VuVLqWIlq0yfkh/1X3Aq
a=ice-options:trickle
a=fingerprint:sha-256
52:09:93:98:AA:2B:93:D2:CA:17:F7:C5:44:42:DC:B7:3E:BE:43:14:A1:4F:B3:1D:C3:3F:9F:07:C
6:50:F5:F0
a=setup:active
a=mid:0
a=sctp-port:5000
a=dcmap:0 subprotocol=“http”;label=“http”
a=dcsa:0 request-target:http://172.17.176.1:55698/imsdc/bootstrap/277416198700300

In one example embodiment, a parameter that is called “request-target” is included in SDP, e.g., as part of the “dcsa” attribute, when establishing a bootstrap data channel. The SDP attribute may contain the URL where the UE can download the application or the list of possible and allowed applications dedicated to its subscriber. The DCMTSI client in the terminal shall use this URL in the HTTP message sent via the bootstrap data channel to retrieve the bootstrap application or application list.

For example, the DCMTSI client in the terminal uses this request-target URL in HTTP request message over the established bootstrap data channel to retrieve the bootstrap application or application list. See an example below in Table 2 below.

TABLE 2
HTTP request

```
GET http://172.17.176.1:55698/imsdc/bootstrap/277416198700300
Headers:
  Content-Length: 0
  Content-Type: text/html
  Accept: text/html
```

In an example embodiment, when DCMF receives such an HTTP request message via bootstrap data channel, it forwards the HTTP request message to the DCSF, DCAR any other Web server as indicated in the request-target of the HTTP request message.

In an example embodiment, when DCMF receives HTTP response to the request, the DCMF forwards the response to the UE via the bootstrap data channel as shown in Table 3 below.

HTTP request

```
HTTP/1.1 200 OK
Headers:
    Content-Type: text/html
      Content-Length: 9278
Body:
  <!DOCTYPE html>
  <html>
  ......
```

The method may comprise providing the address to a DCMF. The DCMF may direct a request from the user equipment for the at least one application or the application list to the address. The request from the user equipment for the at least one application or the application list may comprise a pre-configured address, e.g., a root URL or “/” URL.

In one example embodiment, the DCSF, optionally with the help of DCAR or another function, creates the URL of the DC application or application list for this UE during DC bootstrap establishment and provides the URL to DCMF. Once the bootstrap channel is established and the UE sends a HTTP request message to the “/” URL, DCMF may redirect the request to the URL created by the DCSF where the application or list can be downloaded.

The method may comprise receiving an identifier associated with the bootstrap data channel from a data channel management media function and associating the identifier with the address (URL). The method may comprise receiving a request for the address from the data channel management media function, the request including the identifier. The method may comprise providing the address to the data channel management media function based on the identifier. The DCMF may then direct a request from the user equipment for the at least one application or the application list to the address. The request from the user equipment for the at least one application or the application list may comprise a pre-configured address, e.g., a root URL or “/” URL.

In one example embodiment, the DCMF allocates a unique ID (either a new one or combination of existing ones like IP address, port number, stream ID, etc.) that identifies the bootstrap data channel that is established in the DCMF for a certain UE and sends this ID to the DCSF. The DCSF, optionally with the help of DCAR or another function creates the URL of the DC application or application list for this UE and stores it together with the bootstrap channel ID.

Once the bootstrap channel is established and the UE sends a HTTP request message to the “/” URL, DCMF requests the previously created URL from DCSF by providing the bootstrap channel ID and the redirects the HTTP request from the UE to the URL provided by the DCSF.

Alternatively, the method may comprise receiving a request for the at least one application or the application list from the user equipment via the DCMF, the request including the identifier and directing the request to the address based on the identifier. In this example embodiment the DCMF may forward the HTTP request message from the UE directly to the DCSF and DCSF redirects the request to the stored URL.

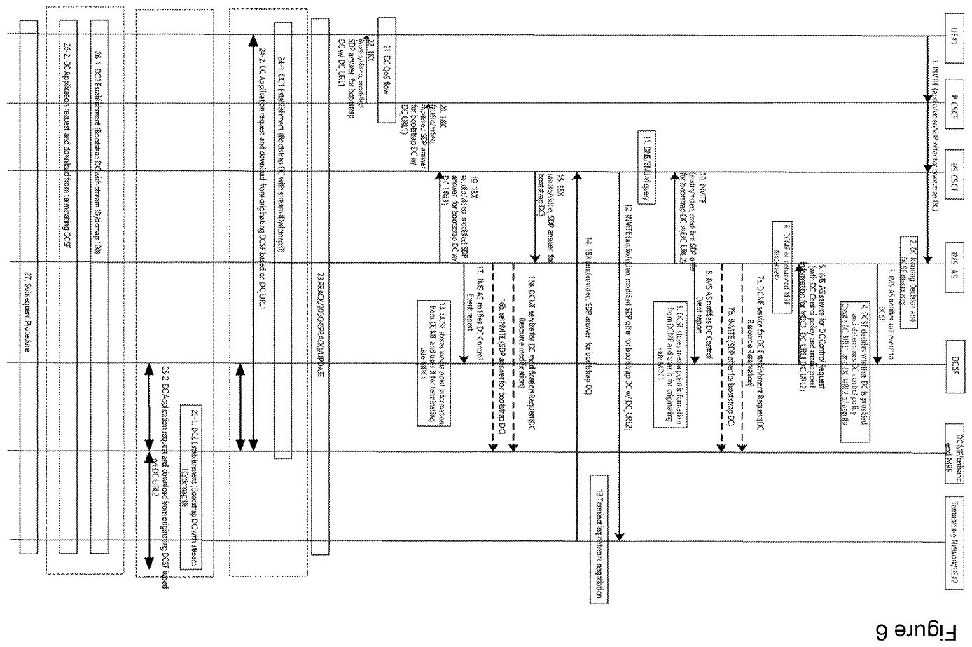

FIG. 6 shows a signalling flow according to an example embodiment.
At 1, a UE sends a SIP INVITE including SDP to establish a bootstrap data channel.
At 2, the IMS AS performs a DC routing decision and DCSF discovery.

SIP attributes like user ID and SDP attributes are extracted by the IMS AS at 3 and forwarded to the DCSF.
At 4, based on subscription and other information DCSF or DCAR (DC Application Repository) creates a URL (URL1) and a further URL (URL2) that indicates the resource of the DC application or application list (this may be e.g., a HTML page). The DCAR is a Web server where the applications, i.e., HTML pages, are stored and retrieved.
At 5, DCSF provides the URLs with other data to IMS AS.
At 6, the IMS AS performs DCMF or enhanced MRF discovery
At 7 DCSF contacts DCMF to establish media resources for the bootstrap channel.

The bootstrap data channel SDP negotiation is completed. As part of the SDP negotiation, the IMS AS sends an with URL and other related data (e.g., endpoint of DCMF media resources) to the UE.

At 24, the bootstrap data channel is established between UE #1 and DCMF via signalling between UE, IMS AS and DCSF. UE #1 sends a HTTP request message with the received URL1 via bootstrap DC to DCMF.

When DCMF receives the HTTP request message, it sends the HTTP message to the DCAR, DCSF or any other Web server as indicated in the URL1 to download the application or application list to the UE.

UE receives the application or application list via the bootstrap DC in the reply to the HTTP request message.

Similarly, at 25, the bootstrap data channel is established between the terminating network/UE #2 and DCMF via signalling between UE, IMS AS and DCSF. The terminating network/UE #2 sends a HTTP request message with the received URL3 via bootstrap DC to DCMF.

When DCMF receives the HTTP request message, it sends the HTTP message to the DCAR, DCSF or any other Web server as indicated in the URL2 to download the application or application list to the terminating network/UE #2.

The terminating network/UE #2 receives the application or application list via the bootstrap DC in the reply to the HTTP request message.

An apparatus may comprise means for receiving a request from a user equipment for establishing a bootstrap data channel with a data channel server, the request including attributes associated with the user equipment, means for determining, based on the attributes, an address indicating resources associated with at least one application or an application list for the user equipment and means for using the address to provide the at least one application or the application list to the user equipment via the bootstrap data channel.

The apparatus may comprise a network function, be the network function or be comprised in the network function or a chipset for performing at least some actions of/for the network function. The network function may be a DCSF or DCAR or webserver.

Alternatively, an apparatus may comprise means for means for providing a request from a user equipment to a network function for establishing a bootstrap data channel with a data channel server, the request including attributes associated with the user equipment, means for receiving, in response to the request, an address indicating resources associated with at least one application or an application list to be provided via the bootstrap channel for the user equipment, the address determined based on the attributes and means for providing a request from the user equipment for the at least one application or the application list to the received address.

The apparatus may comprise the user equipment, such as a mobile phone, be the user equipment or be comprised in the user equipment or a chipset for performing at least some actions of/for the user equipment.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising:
at least one processor; and
at least one memory storing instructions of a network function, wherein the instructions, when executed by the at least one processor, cause the apparatus to perform operations, the operations comprising:
receiving, from a user equipment, a request for establishing a bootstrap data channel with a data channel server, the request including attributes associated with the user equipment;
determining, based on the attributes, an address indicating resources associated with at least one application for the user equipment or an application list for the user equipment; and
providing the at least one application or the application list to the user equipment via the bootstrap data channel using the address.

2. The apparatus according to claim 1, wherein the operations further comprise receiving the request from the user equipment via an application server.

3. The apparatus according to claim 1, wherein the providing comprises providing the address to the user equipment.

4. The apparatus according to claim 3, wherein the providing comprises providing the address to the user equipment via an application server.

5. The apparatus according to claim 4, wherein the providing comprises providing the address to the user equipment in a session description protocol message.

6. The apparatus according to, wherein the operations further comprise:
determining, based on the attributes, a further address indicating resources associated with at least one application for a terminating device or an application list for the terminating device; and
providing the further address to the terminating device.

7. The apparatus according to claim 1, wherein the providing comprises:
providing the address to a data channel media function.

8. The apparatus according to claim 7, wherein the operations further comprise directing a request for the at least one application for the user equipment or the application list for the user equipment received from the user equipment using the address.

9. The apparatus according to claim 8, wherein the request for the at least one application for the user equipment or the application list for the user equipment comprises a pre-configured address.

10. The apparatus according to claim 1, wherein the operations further comprise:
receiving an identifier associated with the bootstrap data channel from a data channel media function; and
associating the identifier with the address.

11. The apparatus according to claim 10, wherein the operations further comprise:
receiving a request for the address from the data channel media function, the request including the identifier.

12. The apparatus according to claim 11, wherein the operations further comprise:
providing the address to the data channel media function based on the identifier.

13. The apparatus according to claim 12, wherein the operations further comprise: directing a request for the at least one application or the application list received from the user equipment using the address.

14. The apparatus according to claim 10, wherein the operations further comprise:
receiving a request for the at least one application or the application list from the user equipment via the data channel media function, the request including the identifier;
directing, the request for the at least one application or the application list, using the address, based on the identifier.

15. The apparatus according to claim 1, wherein the network function comprises one of the following: a data channel application repository, a data channel signalling function, or a webserver.

16. The apparatus according to claim 1, wherein the address comprises a uniform resource locator.

17. A user equipment comprising:
at least one processor; and
at least one memory storing instructions, wherein the instructions, when executed by the at least one processor, cause the apparatus to perform operations, the operations comprising:
providing, to a network function, a request for establishing a bootstrap data channel with a data channel server, the request including attributes associated with the user equipment;
receiving, a response to the request, the response comprising an address indicating resources associated with at least one application for the user equipment to be provided via the bootstrap channel or an application list for the user equipment to be provided via the bootstrap channel, the address determined based on the attributes; and
providing a request for the at least one application or the application list using the address.

18. The user equipment according to claim 17, wherein the providing comprises:
providing the request for establishing the bootstrap data channel from the user equipment via an application server.

19. The user equipment according to claim 17, wherein the operations further comprise:
receiving the address at the user equipment via an application server.

20. The user equipment according to claim 19, wherein the operations further comprise:
receiving the address at the user equipment in a session description protocol message.

21. (canceled)

22. The user equipment according to claim 17, wherein the address comprises a uniform resource locator.

23-28. (canceled)
